(19) United States
(12) Patent Application Publication
(10) Pub. No.: US 2010/0038984 A1
(43) Pub. Date: Feb. 18, 2010

(54) Onboard energy

(76) Inventor: Bailey Gifford Penn, Martinsville, VA (US)

Correspondence Address: Bailey Gifford Penn, 1109 Chatham Rd., Martinsville, VA, 24112, US

(21) Appl. No.: 12/286,786

(22) Filed: Dec. 16, 2008

Related U.S. Application Data
(60) Provisional application No. 61/188,797, filed on Aug. 13, 2008.

(51) Int. Cl. H02K 47/00; H02K 53/00

(52) U.S. Cl. 310/113; 415/916

(57) ABSTRACT

A working electrical system that transfers electricity from a generator through various components back to itself to produce a continuing cycle of electrical energy.

This idea is to take a generator and use it to power fossil fuel burning equipment by using “reverse energy.”

The energy from the generator could be converted back to itself to perform its task, therefore creating “on board energy.”

To start the process or motion, a battery and a starter could be used with other components to start the process of the generator producing the necessary energy to power all electrical functions as well as producing energy for itself.

The idea and its set-up will vary according to the type of equipment it is applied to so that it can fulfill all its functions.

The process of making the components and all necessary parts are by molds and casting and necessary processes for building mechanical parts.

This application is based on a U.S. provisional application No. 61/188,797 filed Aug. 3, 2008 entitled Onboard Energy.

### FIELD OF IDEA

The present idea relates to the field of electricity and the process of making it.

### BACKGROUND OF THE INVENTION

Electricity was led in study by Benjamin Franklin an inventor, until the time of Thomas A. Edison. Since those days, many ideas has come forth from the discovery of electricity including the idea of generators which produce this energy.

Generators produce electricity for a host of useful things in the lives of mankind such as lights heat transportation and helps in the use of many useful devices in the world.

### SUMMARY

Since the invention of electricity, it has been a helpful source of energy in the lives of mankind and have had great innovations for mankind to the fact now this nation and some other countries depend upon the use of it in some form or another.

So the process of using reverse energy to power fossil fuel burning equipment would be a very helpful process for mankind.

1. This process of using a generator to produce its own energy through a reverse process can supply the necessary current to power equipment that burns fossil fuel, replacing the need for fossil fuel making it an alternative power source.

2. Furthermore in claim 1 reversing the energy through necessary components to generate energy needed to operate a motor to turn the generator would in fact help create on board energy hopefully cutting back on greenhouse gases and global warming.

3. All components output will be according to the need of the of equipment that it is on to generate the necessary power for that particular equipment.

4. As for claim 3 the need for certain components will vary also according to the needs of the individual equipment even the design of said equipment.
